(19) United States
(12) Patent Application Publication
(10) Pub. No.: US 2011/0283751 A1
(43) Pub. Date: Nov. 24, 2011

(54) ANTI-THEFT DEVICES FOR PORTABLE OBJECTS SUCH AS LAPTOPS

(76) Inventor: Meir Avganim, M. P. Nachal Sorek (IL)

(21) Appl. No.: 13/132,885

(22) PCT Filed: Dec. 10, 2009
(86) PCT No.: PCT/IL2009/001171

§ 371 Date: Aug. 12, 2011

(30) Foreign Application Priority Data
Dec. 22, 2008 (IL) 196116

(51) Int. Cl. E05B 73/00

(52) U.S. Cl. 70/18

(57) ABSTRACT

For use in arresting a portable object such as flat laptop computers (10) having a housing with an underside housing cover (13) by a cable (46) adapted to be tied to an immovable object (45), the cable being provided with a key-operated locking device (44) comprising a tip (43) insertable into a dedicated slot (22A) associated with the portable object and turned by the key (41) by an angle less than 180 thereby preventing the withdrawal of the tip from the dedicated slot, an auxiliary base-plate (20) configured to fit against the underside housing cover (13) and comprising at-least one dependent wall portion (22C) formed with the dedicated slot (22A), and means (11′) for securing the base-plate to the underside housing cover.

### FIELD OF THE INVENTION

The present invention generally relates to security devices, and specifically to lockable devices of the type comprising a lock-body arrestable against a dedicated slot formed in a side-wall of the protected object, such as a portable computer, and a cable connected at one end to the lock-body whereas the other end is adapted to be tied to an immovable object such as a table leg.

### BACKGROUND OF THE INVENTION

Locks of the type above referred to are widely used. The most popular models are known in commerce as “KENSINGTON” locks (see for example U.S. Pat. Nos. 7,100,403, 7,111,479, and many others).

Rapid advances in technology continuously contribute to development of smaller computers, including smaller portable computers such as laptops and notebooks. As external dimensions are reduced in the portable computers, so is generally an area of a side-wall of the computer in which is formed the dedicated slot adapted to accommodate the lock-body. In some cases, the area is reduced to such an extent that the dedicated slot cannot be formed in the side-wall. Such is the case, for example, with the Apple MacBook Air portable computer. Consequently, the locking technique of the type above referred to is not pacticable. Computers of this type shall be herein referred to as “Flat Computers”.

It is therefore the prime object of the invention to offer a solution to this problem.

It is a further object of the invention to provide a novel locking arrangement that will eliminate the need for a dedicated slot to be formed on a side wall of the protected object.

### SUMMARY OF THE INVENTION

According to one aspect of the invention there is provided a method of arresting a portable object having a housing with an underside housing cover by a cable adapted to be tied to an immovable object. The cable is provided with a key-operated locking device comprising a tip insertible into a dedicated slot associated with the portable object and turned by the key by an angle less than 180° thereby preventing the withdrawal of the tip from the dedicated slot. The method comprises the steps of providing an auxiliary base-plates formed with at-least one dependent wall portion comprising said dedicated slot; attaching the auxiliary base-plate to the underside housing cover of the portable object; and arresting the auxiliary base-plate to an immovable object by said locking device.

According to another aspect of the invention, the auxiliary base-plate is configured to fit against the underside housing cover and comprising at-least one dependent wall portion formed with said dedicated slot, and means for securing the base-plate to the underside housing cover.

### BRIEF DESCRIPTION OF THE DRAWINGS

These and additional constructional features and advantages of the invention will become more clearly understood in the light of the following description of several preferred embodiments thereof given by way of example only, with reference to the attached drawings, wherein—

FIG. 1 is a schematic front-side view of a typical flat computer housing;

FIG. 2 is a cross-sectional view II-II of the computer housing of FIG. 1;

FIG. 3 is a schematic first side view of an auxiliary base-plate designed according to the principles of the present invention;

FIG. 4 is a schematic second side view of the base-plate of FIG. 3;

FIG. 5 is a schematic side view of the base-plate opposite to that of FIG. 4;

FIG. 6 is a schematic top view of the base-plate of FIG. 3;

FIG. 7 is a schematic sectional view taken along line VII-VII of FIG. 6 including a cross-sectional view of a first lock-body, according to a first preferred embodiment of the present invention;

FIG. 8 illustrates a position prior to mounting the first lock-body to the base-plate;

FIG. 9 shows a different view of FIG. 8;

FIG. 10 illustrates the locking position of the first lock-body in the base-plate;

FIG. 11 is a schematic sectional view taken along line XI-XI of FIG. 6 including a cross-sectional view of a second lock-body, according to another embodiment of the present invention;

FIG. 12 illustrates a position prior to mounting the second lock-body to the base-plate;

FIG. 13 shows the second lock-body mounted on the base-plate prior to locking; and

FIG. 14 illustrates the locking position of the second lock-body to the base-plate.

### DETAILED DESCRIPTION OF THE PREFERRED EMBODIMENTS

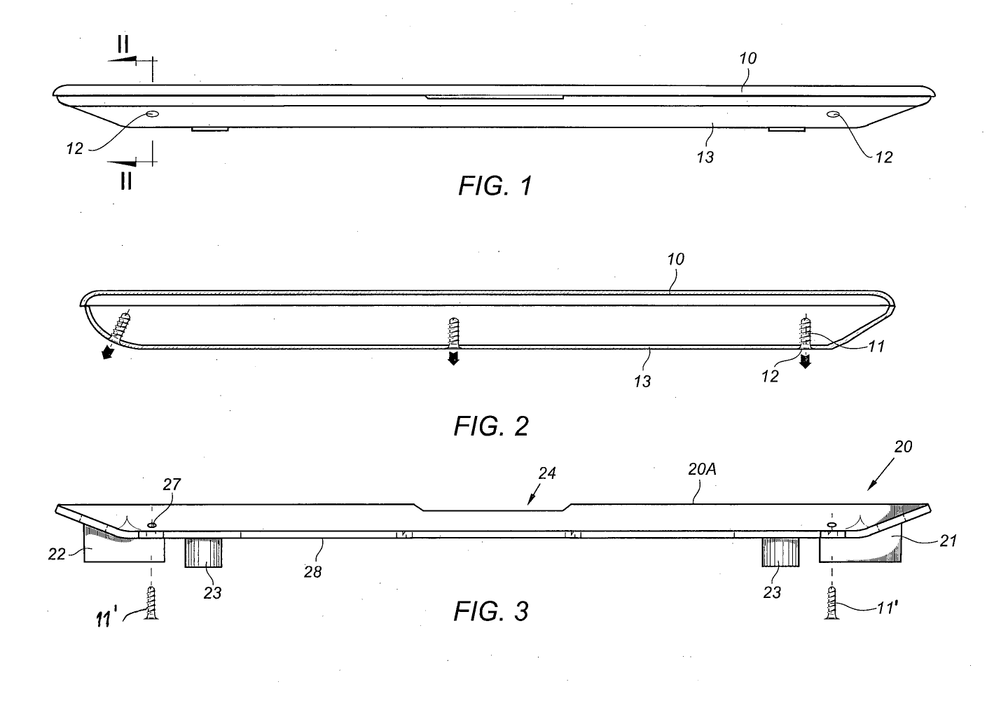

In FIGS. 1 and 2, a portable object which may be, for example, a flat computer housing generally designated 10, is shown in a front view and a cross-sectional view II-II, respectively. Cross-sectional view II-II cuts through three screw holes 12 positioned on an underside housing cover 13 of flat computer 10, in each screw hole inserted a screw 11. On an opposing side of underside housing cover 13 are additional three screw holes 12 and inserted screws 11. Screws 11 may be used soley to secure underside housing cover 13 of computer 10, and/or to secure parts and components (not shown) inside the computer. Optionally, screw holes 12 and screws 11 may be used to attach an object or a device to underside 13. Optionally, the quantity and/or location of screws holes 12 and screws 11 on underside 13 may differ from one model of flat computer to another.

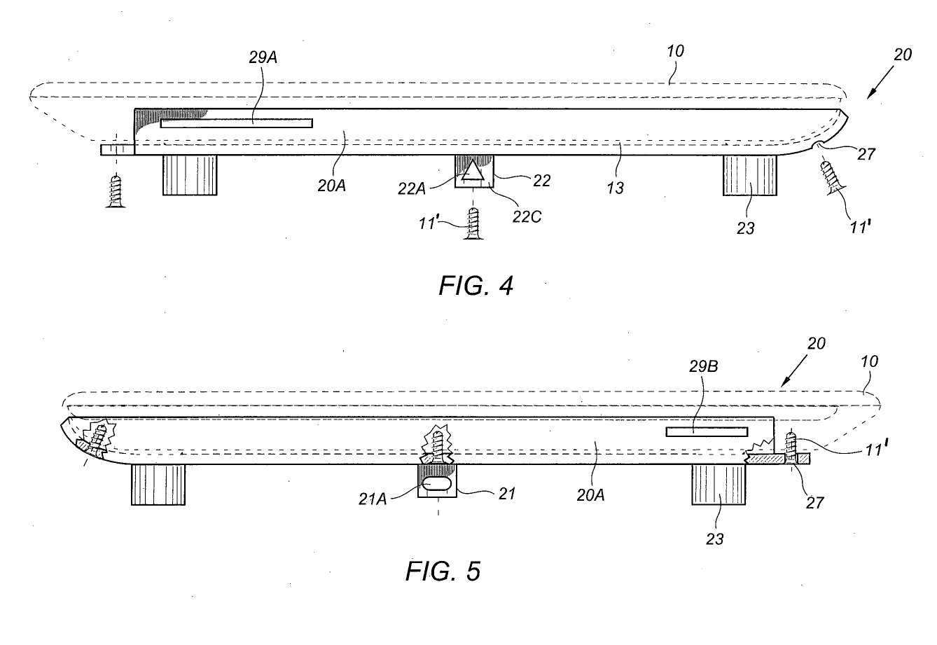

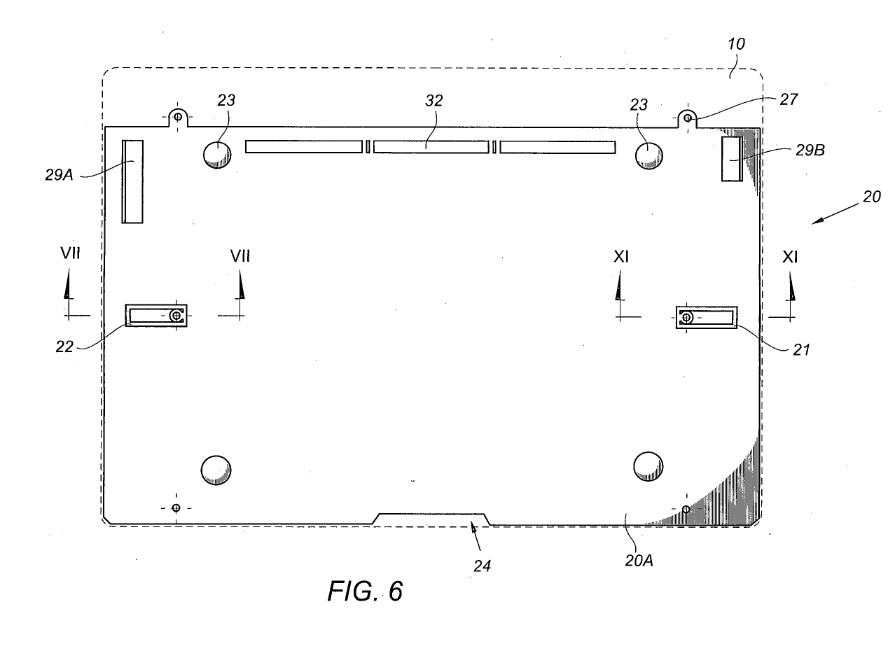

In FIGS. 3, 4, 5 and 6, an auxiliary base-plate 20 for securing computer 10 to an immovable object (not shown) is shown in a front view, left side view, right side view, and top view, respectively. Base-plate 20 is configured in various respect to fit the underside housing cover 13. Hence, it may include a plurality of utility openings adapted to allow access to compartments, openings, and connectors of computer 10; it may include ventilation openings 32 which may align with ventilation openings in computer 10; it may include a port connector opening 29A through which devices and accessories may be connected to computer 10; Additionally or alternatively, it may include a power connector opening 29B through which a power cord may be inserted and connected to computer 10; it may further comprise recesses such as, for example recess 24, for facilitating user access while opening the computer; and it may include one or more holes 27 through which screws may be inserted for attaching the auxiliary base-plate 20 to underside 13 of computer 10.

Attachment of the base-plate 20 to underside housing cover 13 is typically done by first placing the flat computer 10 in right-side-down position (underside 13 is facing upwards) which allows for removing screws 11 from screw holes 12. Following removal of screws 11, base-plate 20 is onto underside 13 such that the one or more holes 27 thereof are aligned with screw holes 12 on the underside housing cover 13. Additionally, utility openings such as, for example port connector opening 29A, power connector opening 29B, and ventilation openings 32, are properly positioned relative to underside 13. Once aligned, replacement (longer), screws 11′ are inserted through holes 27 into screw holes 12, and tightened. Following attachment of base-plate 20 to underside 13, computer 10, together with the attached plate, may be placed in a right-is side up position (underside 13 is facing downwards) and set to rest on a flat surface on supports 23 included in the base-plate.

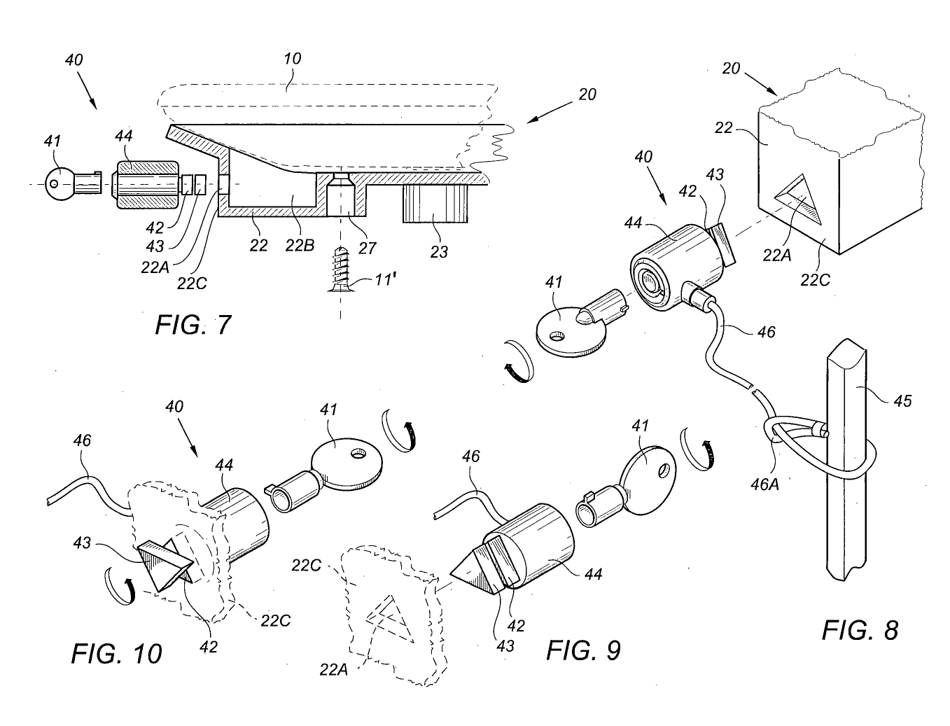

Base-plate 20 further comprises a first dedicated slot 22A which may be formed in a dependent wall 22C of a first lock chamber 22. First lock chamber 22, which may be integrally formed as a part of auxiliary base-plate 20, comprises a housing with an internal cavity (designated 22B in FIG. 7) to allow for a lock tip (designated 43 in FIG. 7 below) to be inserted through first dedicated slot 22A in a locking operation. Optionally, first lock chamber 22 may be separately attached to plate 20 by fastening means such as, for example, a screw, a bolt, or the like. First dedicated slot 22A, which may be triangular as shown, may optionally have other shapes compatible with the shape of the lock tip (see below).

As shown in FIGS. 7 and 8, first dedicated slot 22A is adapted to become selectively locked against, and unlocked from, a first lock-body 40. First lock-body 40 comprises a housing 44, for example a cylindrical housing, accommodating a locking mechanism which may be of the push-button type, operable by key 41. Affixed to housing 44 is one end of a security cable 46, for example a metal cable, including a looped end 46A by which the cable may be tied around a fixed object such as a table leg 45.

As shown in greater detail in FIGS. 9 and 10, locking of first lock-body 40 to depended wall 22C of first lock chamber 22, and thereby to the back-plate 20, is achieved by inserting a pair of triangular overlapping lock tips 42 and 43 that fit respectively into and through first dedicated slot 22A. The tip 42 is fixed to lock body 44. A mechanism in housing 44, operated by key 41, is adapted to rotate tip 43 in either direction, for example by 60°, to complete the locking operation as shown in FIG. 10.

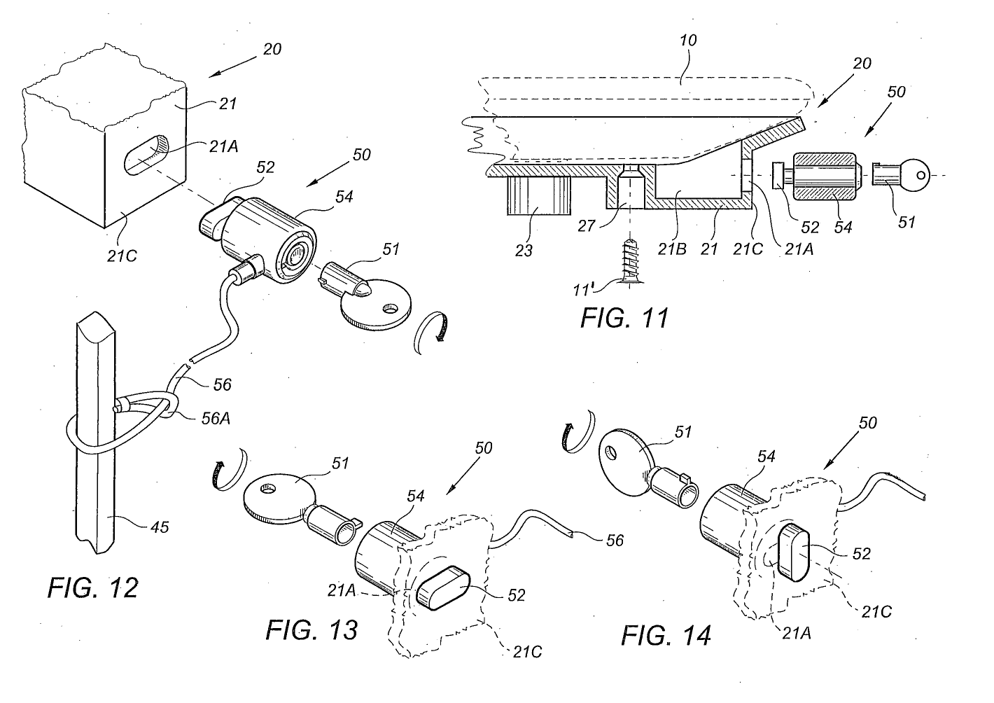

Auxiliary lock-plate 20 may additionally comprise, say, for extra safety, a second dedicated slot 21A which may be formed in a dependent wall 21C of a second lock chamber 21. Second lock chamber 21, which may be integrally formed as a part of the plate, comprises a housing with an internal cavity (designated 21B in FIG. 11) to allow for a lock tip 52 to be inserted through second dedicated slot 21A in a locking operation. Optionally, second lock chamber 21 may be separately attached to lock-plate 20 by fastening means such as, for example, a screw, a bolt, or the like. Second dedicated slot 21A, which may be of an oblong rectangular shape as shown, may optionally have other shapes compatible with the shape of the lock tip.

As shown in FIGS. 11 and 12, second dedicated slot 21A is adapted to become selectively locked against, and unlocked from, a second lock-body 50. Second lock-body 50 comprises a housing 54, for example a cylindrical housing, accommodating a locking mechanism which may be of the push-button type, operable by a key 51. Affixed to housing 54 is one end of a security cable 56, for example a metal cable, including a looped end 56A by which it can be tied around table leg 45.

As shown in greater detail in FIGS. 13 and 14, locking of second lock-body 50 to dependent wall 21C of second lock chamber 21, and thereby to back-plate 20, is achieved by inserting a lock tip 52 that fits into and through second dedicated slot 21A. A mechanism in housing 54, operated by key 51, is adapted to rotate tip 52 in either direction, for example by 90°, to complete the locking operation as shown in FIG. 14.

Those skilled in the art to which this invention pertains will readily appreciate that numerous changes, variations and modifications can effectuated without departing from the scope of the invention as defined in and by the appendent claims.

What is claimed is:

1. A method of arresting a portable object having a housing with an underside housing cover by a cable adapted to be tied to an immovable object, the cable being provided with a key-operated locking device comprising a tip insertable into a dedicated slot associated with the portable object and turned by the key by an angle less than 180° thereby preventing the withdrawal of the tip from the dedicated slot, the method being characterized by the steps of:—
i) providing an auxiliary base-plates formed with at-least one dependent wall portion comprising said dedicated slot;
ii) attaching the auxiliary base-plate to the underside housing cover of the portable object; and
iii) arresting the auxiliary base-plate to an immovable object by said locking device.

2. The method as claimed in claim 1 wherein the portable object is a portable computer.

3. The method as claimed in claim 2 wherein the portable computer is a flat computer (as herein defined).

4. The method as claimed in claim 3 wherein the underside housing cover is mounted to the computer housing by screws, the method being further characterized by the steps of:—
i) unscrewing the screws.
ii) fitting the base-plate against the underside housing cover; and
iii) using replacement screws to fasten the base-plate to the underside housing cover.

5. The method as claimed in claim 4 wherein the said at least one dependent wall forms a part of a locking chamber.

6. The method as claimed in claim 5 wherein the said key operated locking device comprises a lock-body provided with a first, fixed tip, and a second, rotatable tip of a shape overlapping the first tip, the first tip being adapted to fit the dedicated slot while the second tip is adapted to become rotated after passing the said wall through the dedicated slot.

7. The method as claimed in claim 6 wherein the shape of the dedicated slot, the first tip and the second tip is triangular, the rotation of the second tip being by an angle of about 60°.

8. For use in arresting a portable object having a housing with an underside housing cover by a cable adapted to be tied to an immovable object, the cable being provided with a key-operated locking device comprising a tip insertable into a dedicated slot associated with the portable object and turned by the key by an angle less than 180° thereby preventing the withdrawal of the tip from the dedicated slot, an auxiliary base-plate configured to fit against the underside housing cover and comprising at-least one dependent wall portion formed with said dedicated slot, and means for securing the base-plate to the underside housing cover.

9. The auxiliary base-plate as claimed in claim 8 wherein the underside housing cover is fastened to the portable object by screws, said means comprise screws replacing the said fastening screws.
